(19) United States
(12) Patent Application Publication
(10) Pub. No.: US 2026/0139531 A1
(43) Pub. Date: May 21, 2026

(54) FORWARD LATCHING HANDLE

(71) Applicant: Marine Town Inc., New Taipei City (TW)

(72) Inventor: Chin-Chung TUNG, New Taipei City (TW)

(21) Appl. No.: 18/951,705

(22) Filed: Nov. 19, 2024

(51) Int. Cl. E05C 1/14; E05B 13/00; E05C 1/00

(52) U.S. Cl. CPC E05C 1/145; E05B 13/002; E05C 1/004

(57) ABSTRACT

A forward latching handle for opening and closing a door panel, comprising: a main body having a pivot part, an installation hole, and a mounting slot, the pivot part having a pivot shaft; a handle pivotally connected to the pivot shaft and pivoting between a closed and an open position, the handle moving from the closed position to the open position along a direction identical to an opening direction of the door panel; a linkage connected to the handle, with a rod part rotating between a first and a second position; and a stopping device having a slider slidably disposed in the mounting slot, and an elastic member abutting against one side of the slider, the slider connected to the linkage and moving between a stop and an avoidance position. The handle, linkage, and stopping device cooperate to place the present application in either a locked or an open status.

### BACKGROUND OF THE APPLICATION

### Field of the Application:

The present application relates to handles, and more particularly, to a forward latching handle.

### Description of the Related Art:

Generally, an object used for housing other objects usually comprises a cover for optionally closing the housing space, and a building is usually provided with a door panel for optionally separating neighboring spaces. To facilitate a conveniently and easily opening and closing of the cover or the door panel, a handle is installed on the cover or the door panel.

However, the moving direction of the conventional handle is usually different from the opening direction of the cover or the door panel, such that when opening the cover or the door panel by the handle, a hand-jamming situation often occurs, causing the difficulty in use and inconvenience of force imposing.

### SUMMARY OF THE APPLICATION

The present application aims at resolving the issue of the conventional handle easily having hand-jamming situation, which causes the difficulty in use and inconvenience of force imposing.

For achieving the aforementioned objectives, an embodiment of the present application provides a forward latching handle disposed on a door panel for controlling an opening and closing of the door panel, the door panel having a baffle on one side thereof, the forward latching handle comprising:

a main body comprising a pivot part, an installation hole, and a mounting slot; the pivot part having a pivot shaft, the installation hole passing through the main body along an axial direction thereof, the mounting slot being arranged along a radial direction of the main body and in communication with the installation hole;

a handle pivotally connected to the pivot shaft and pivotable about the pivot shaft between a closed position and an open position, the handle having a pushing part disposed on one side in adjacent to the installation hole, the handle moving from the closed position to the open position along a direction which is identical to an opening direction of the door panel;

a linkage comprising a shaft part and a rod part, the shaft part passing through the installation hole along the radial direction of the main body, the rod part rotationally mounted around the shaft part and rotating about the shaft part between a first position and a second position, the rod part having a first linkage end and an opposite second linkage end, the first linkage end abutting against the pushing part; and

a stopping device comprising a slider and an elastic member, the slider slidably disposed in the mounting slot along the radial direction of the main body, the elastic member abutting against one side of the slider, the slider having a through hole through which the second linkage end passes to abut against, the slider slidably moving between a stop position and an avoidance position;

wherein the elastic member provides a pushing force to control the slider to push the baffle at the stop position, and simultaneously controls the rod part at the first position and the handle at the closed position; when the handle pivots from the closed position to the open position, the pushing part pushes the rod part to the second position, and simultaneously controls the slider to move to the avoidance position.

With such configuration, the handle moves from the closed position to the open position in a direction identical to the opening direction of the door panel, allowing the user to open the door panel more easily and with less effort when imposing the force for opening the door panel.

### BRIEF DESCRIPTION OF THE DRAWINGS

FIG. 1 is a perspective view of the forward latching handle in accordance with an embodiment of the present application, illustrating the handle in the locked status.

FIG. 2 is a perspective view of the forward latching handle in accordance with an embodiment of the present application taken from another point of view.

FIG. 3 is an exploded view of the forward latching handle in accordance with an embodiment of the present application.

FIG. 4 is a cross-sectional view taken along line A-A in FIG. 1.

FIG. 5 is a cross-sectional view taken along line B-B in FIG. 1.

FIG. 6 is a perspective view of the forward latching handle in accordance with an embodiment of the present application, illustrating the handle in the open status.

FIG. 7 is a cross-sectional view taken along line C-C in FIG. 6.

FIG. 8 is a cross-sectional view taken along line D-D in FIG. 6.

FIG. 9 is a schematic view of the operation status of the forward latching handle in accordance with an embodiment of the present application, illustrating the handle being in the locked status and disposed on the door panel.

FIG. 10 is a schematic side view of the operation status of the forward latching handle in accordance with an embodiment of the present application.

FIG. 11 is a schematic view of the operation status of the forward latching handle in accordance with an embodiment of the present application, illustrating the handle being in the open status and disposed on the door panel.

FIG. 12 is a schematic side view of the operation status of the forward latching handle in accordance with an embodiment of the present application.

### DETAILED DESCRIPTION OF THE APPLICATION

The aforementioned and further advantages and features of the present application will be understood by reference to the description of the preferred embodiment in conjunction with the accompanying drawings where the components are illustrated based on a proportion for explanation but not subject to the actual component proportion.

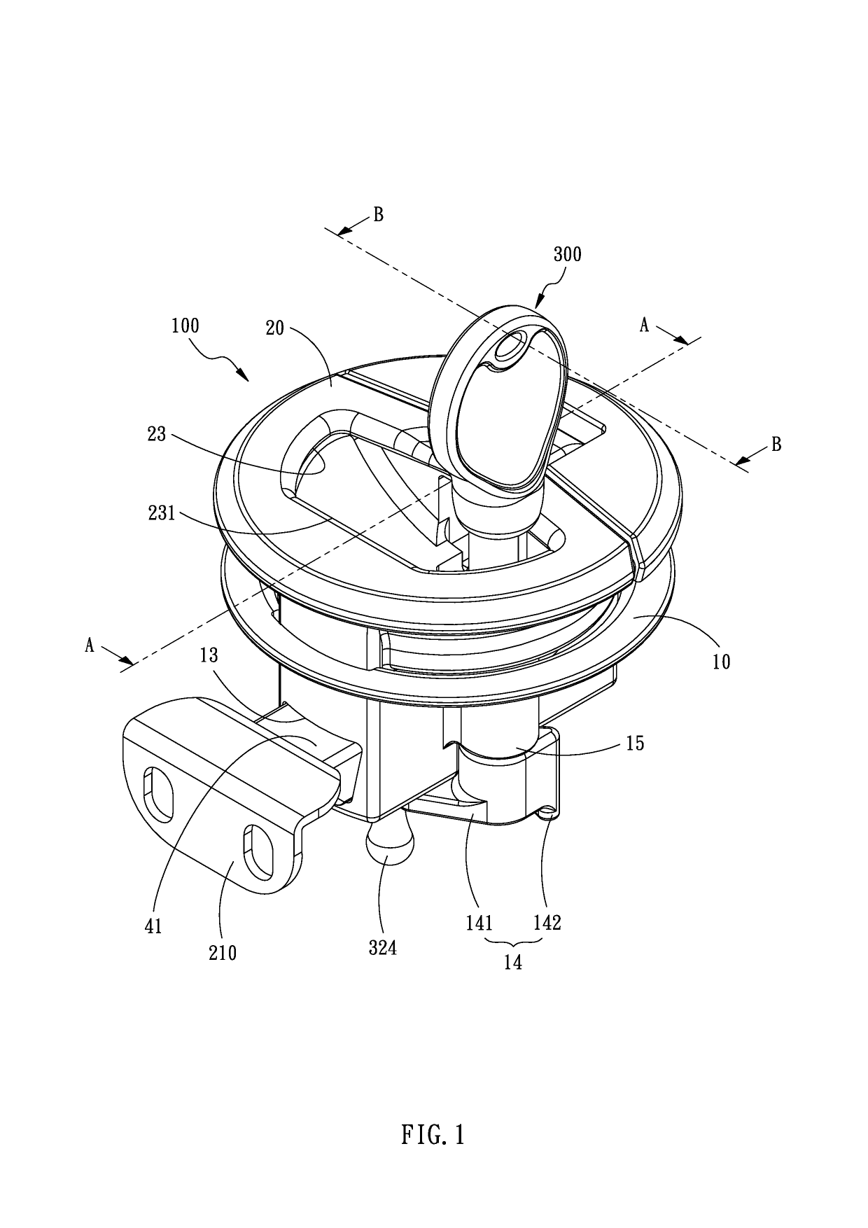

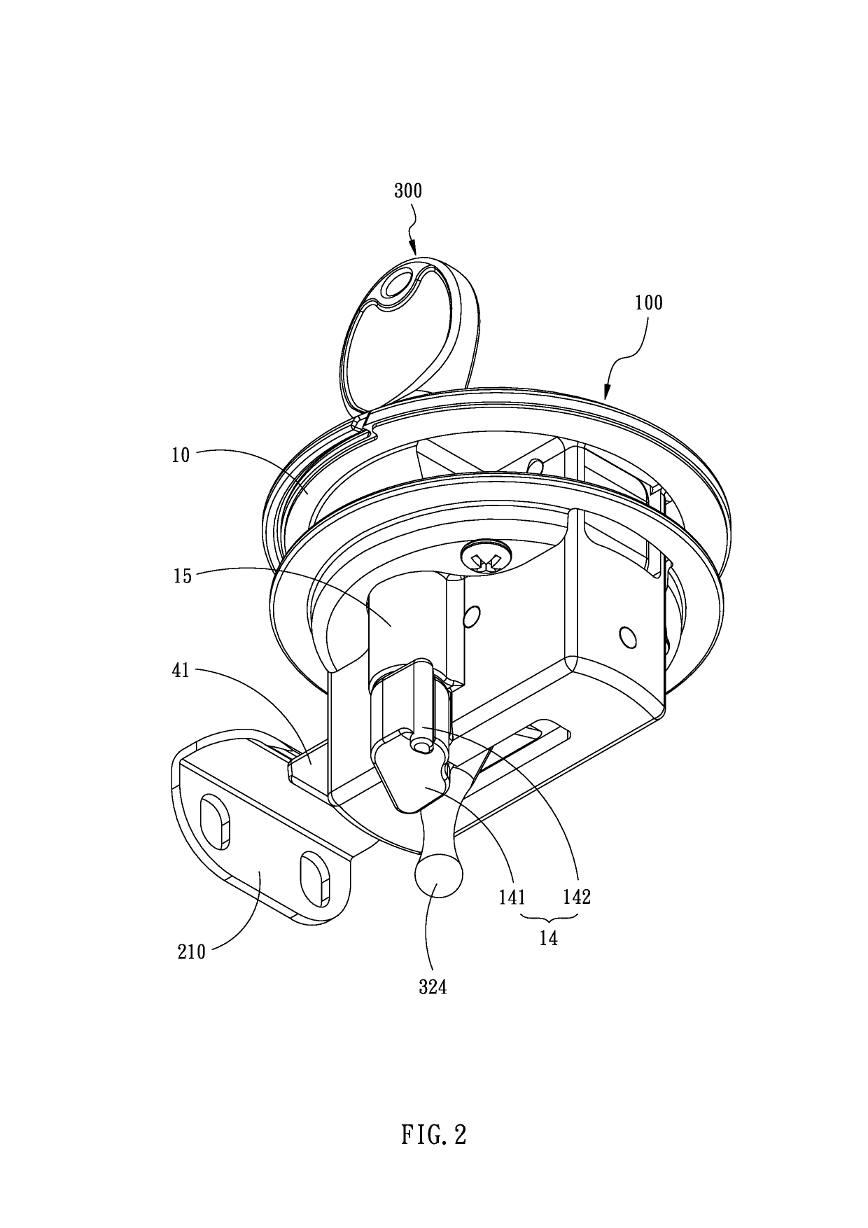

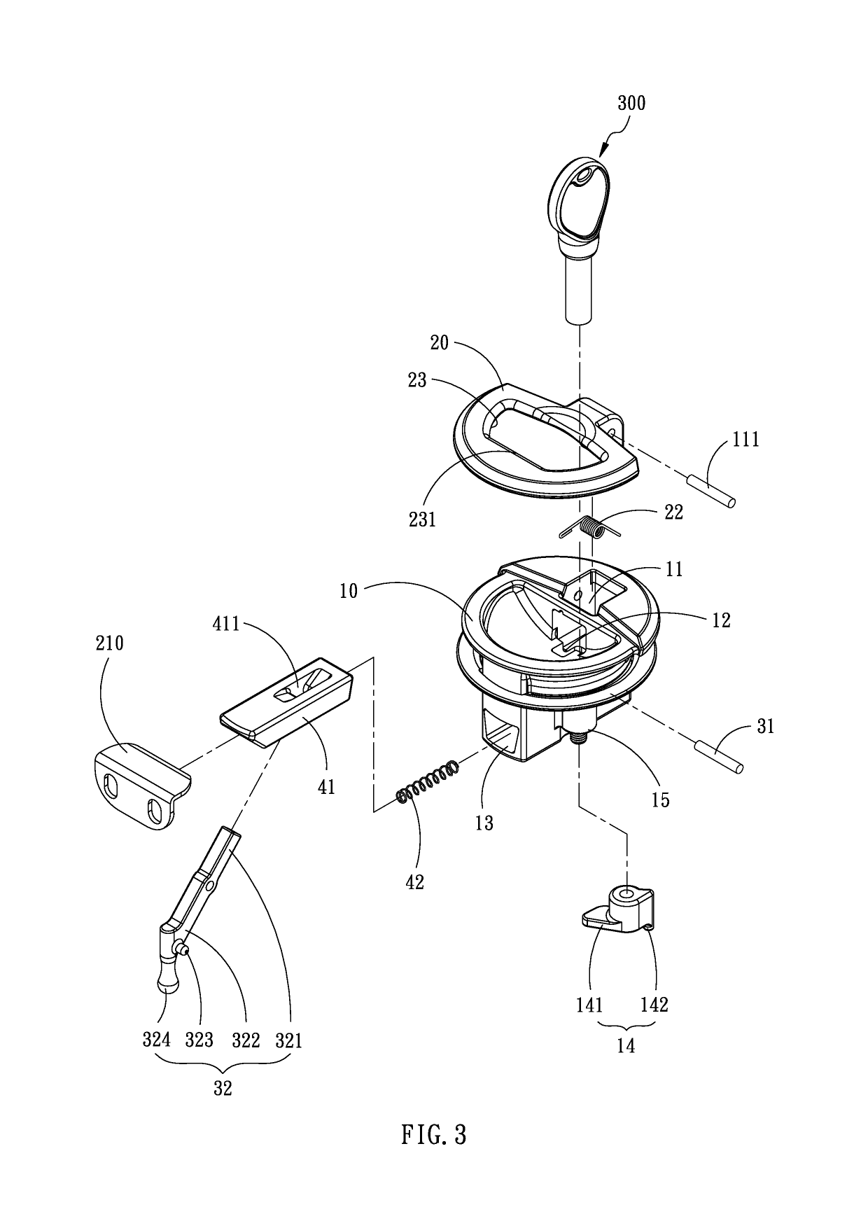

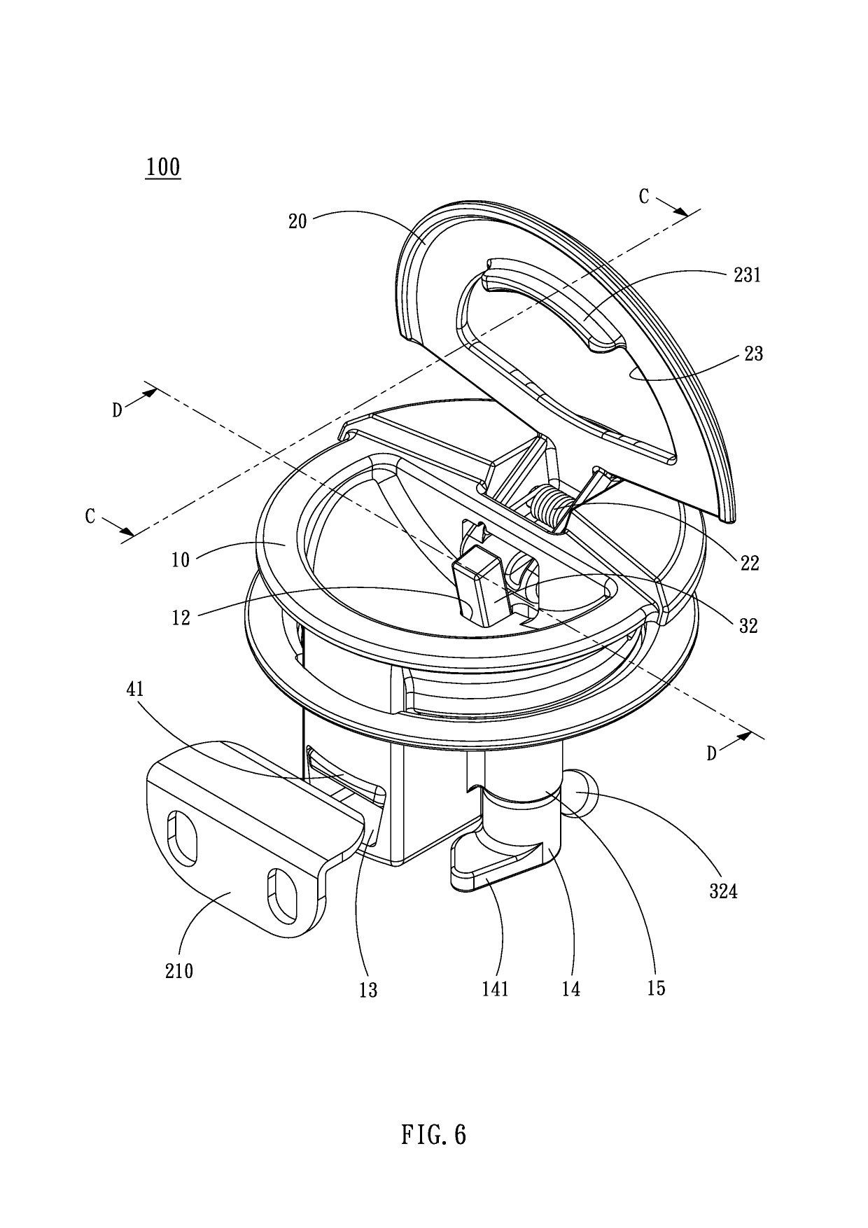

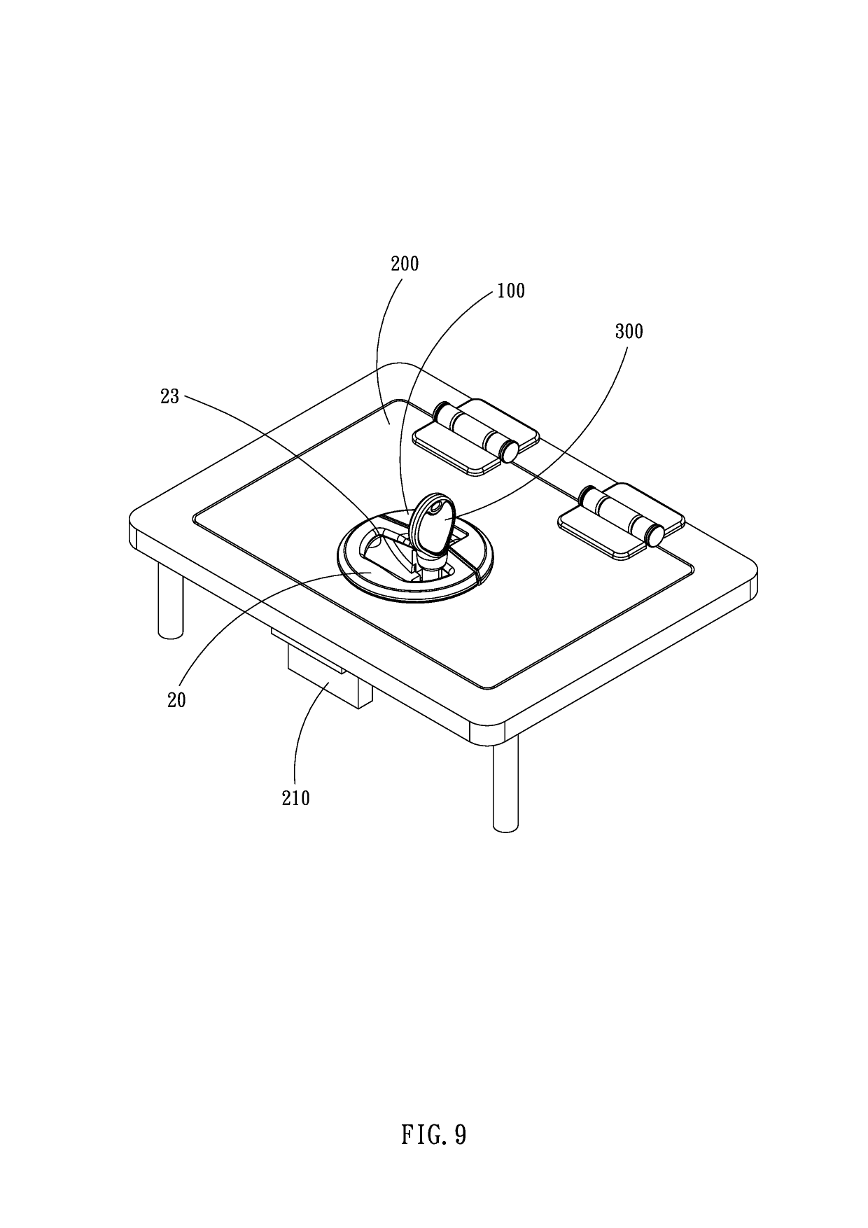

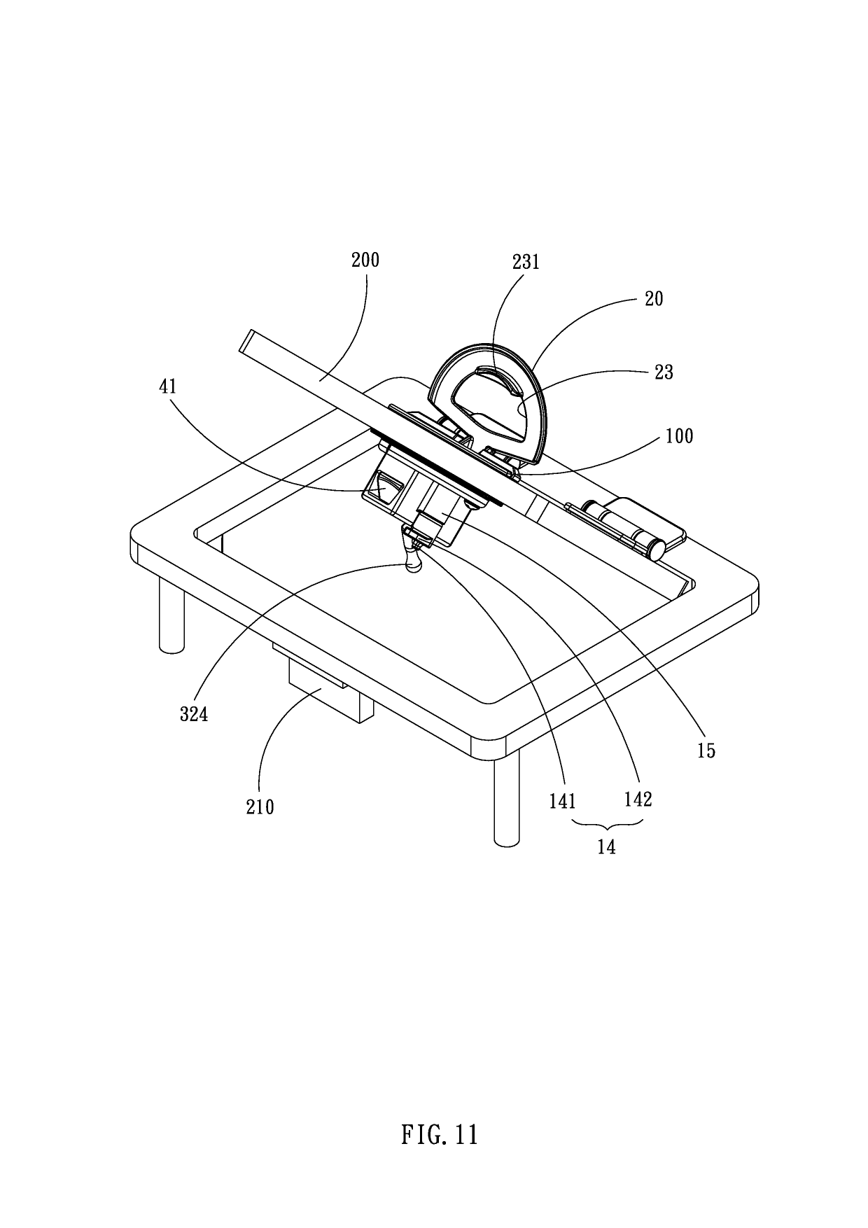

Referring to FIG. 1 to FIG. 12, the present application provides a forward latching handle 100, which is disposed on a door panel 200 for controlling the opening and closing of the door panel 200. The door panel 200 comprises a baffle 210 on one side thereof. The forward latching panel 100 comprises a main body 10, a handle 20, a linkage 30, and a stopping device 40. Therein, the door panel 200 is allowed to be a cover applicable to an object having a housing space for optionally closing or sealing the housing space, or a door applicable to a building for optionally separating the neighboring space.

The main body 10 comprises a pivot part 11, an installation hole 12, and a mounting slot 13. The pivot part 11 has a pivot shaft 111. The installation hole 12 passes through the main body 10 along an axial direction thereof and arranged on one side of the pivot part 11 in adjacent to the bottom of the main body 10. The mounting slot 13 is arranged along a radial direction of the main body 10 and in communication with the installation hole 12. Also, the mounting slot 13 is arranged on one side of the installation hole 12 in adjacent to the bottom of the main body 10. Therein, the main body 10 is formed in an approximately column shape.

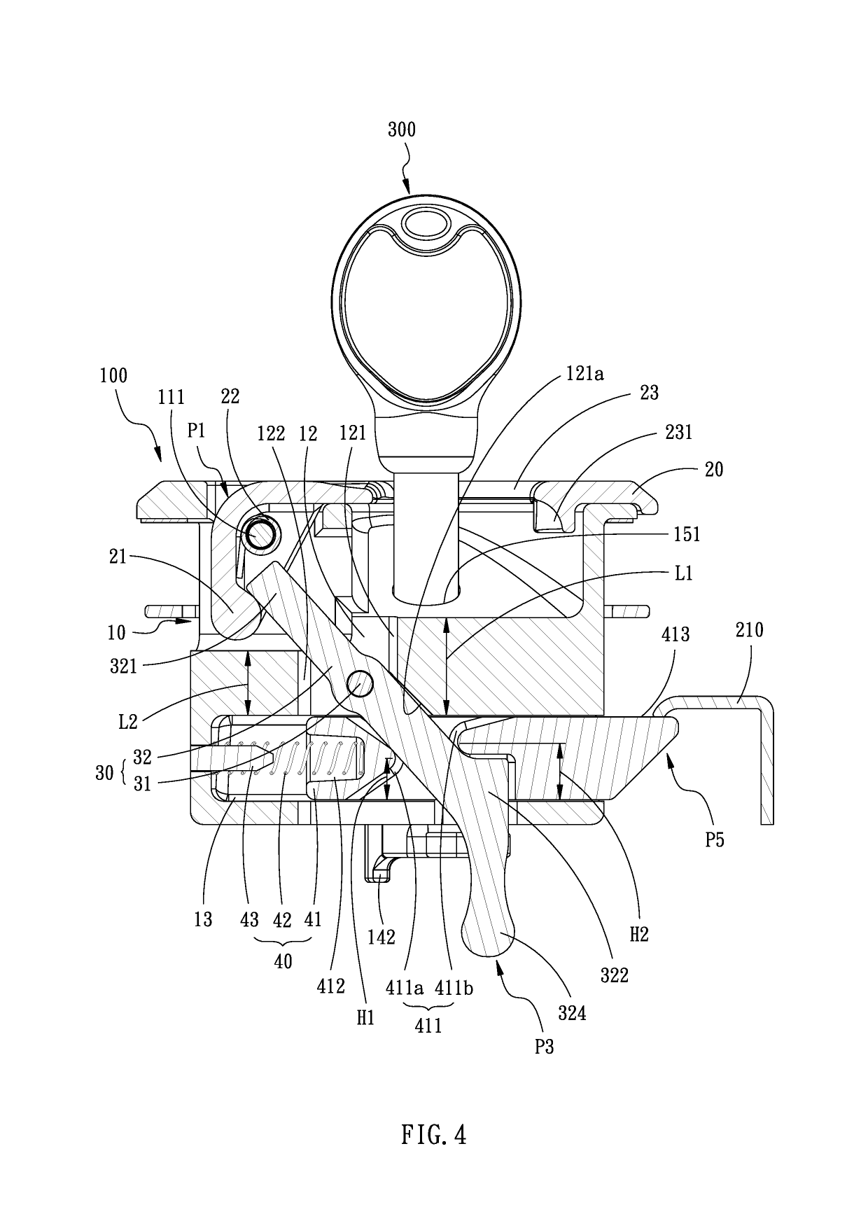

Referring to FIG. 4, in the embodiment, the installation hole 12 comprises a first side wall 121 and a second side wall 122 disposed on two radial sides thereof, wherein the first side wall 121 is arranged closer to the baffle 210 compared to the second side wall 122. The first side wall 121 has a first length L 1 along the axial direction of the main body 10, while the second side wall 122 has a second length L 2 along the axial direction of the main body 10, and the first length L 1 is greater than the second length L 2. Therein, the first side wall 121 comprises an inclined section 121 a on one side thereof away from the pivot part 11.

The handle 20 is pivotally connected to the pivot shaft 111, and pivotable about the pivot shaft 111 between a closed position P 1 and an open position P 2. The handle 20 comprises a pushing part 21 disposed on one side in adjacent to the installation hole 12. Therein, the handle 20 moves from the closed position P 1 to the open position P 2 in a direction identical to the opening direction of the door panel 200, allowing the user to open the door panel 200 more smoothly and conveniently.

Referring to FIG. 1 to FIG. 8, in the embodiment, the handle 20 comprises a recover member 22 mounted around the pivot shaft 111. The recover member 22 provides a recovering force to control the handle 20 to be normally located at the closed position P 1. Therefore, when an externally imposed force is removed, the recover member 22 directly recovers the handle 20 from the open position P 2 to the closed position P 1. Therefore, a manually closing operation by use of the handle 20 is saved, facilitating the convenience of usage and reducing time cost. Therein, the recover member 22 is allowed to be a torque spring.

Referring to FIG. 1 to FIG. 8, in the embodiment, the handle 20 comprises a grip hole 23 passing therethrough, with a grip part 231 disposed on an inner periphery of the grip hole 23, such that the user is able to grip the grip part 231, so as to control the handle 20 to pivot between the closed position P 1 and the open position P 2. Therein, user’s hand is able to pass through the grip hole 23 to grip the grip part 231, thereby more stably and conveniently controlling the position of the handle 20 for opening or closing the door panel 200.

The linkage 30 comprises a shaft part 31 and a rod part 32. The shaft part 31 passes through the installation hole 12 along the radial direction of the main body 10. The rod part 32 is rotationally mounted around the shaft part 31, and rotates about the shaft part 31 between a first position P 3 and a second position P 4. The rod part 32 comprises a first linkage end 321 and an opposite second linkage end 322. The first linkage end 321 abuts against the pushing part 21, so that the handle 20 controls the position of the rod part 32 through the pushing part 21.

The stopping device 40 comprises a slider 41 and an elastic member 42. The slider 41 is slidably disposed in the mounting slot 13 along the radial direction of the main body 10. The elastic member 42 abuts against one side of the slider 41. The slider 41 comprises a through hole 411 through which the second linkage end 322 passes to abut against. The slider 41 is allowed to slide between a stop position P 5 and an avoidance position P 6. Therein, the elastic member 42 permanently provides a pushing force to normally push the slider 41 to the stop position P 5, and simultaneously controls the linkage 30 to be normally at the first position P 3 and controls the handle 20 to be normally at the closed position P 1. Therefore, when the user closes the door panel 200 and removes the external force imposed thereon, the recover member 22 of the handle 20 and the elastic member 42 of the stopping device 40 efficiently drive the slider 41 to move to the stop position P 5, whereby the forward latching handle 100 is quickly recovered to the locked status, effectively closing the door panel 200.

Referring to FIG. 1 to FIG. 8, in the embodiment, the stopping device 40 further comprises a positioning member 43 disposed on one side of the elastic member 42 away from the slider 41. The slider 41 comprises a positioning hole 412 disposed on one side thereof in adjacent to the elastic member 42. The elastic member 42 has one end mounted around the positioning member 43 and another end inserted in the positioning hole 412. Therefore, the positioning member 43 and the positioning hole 412 limit the position of the elastic member 42, such that the elastic member 42 actually provides the pushing force to the slider 41. Therein, the elastic member 42 is allowed to be a compression spring.

Referring to FIG. 1 to FIG. 5 and FIG. 10, in the embodiment, the slider 41 comprises a protruding stopping face 413 on one side thereof away from the elastic member 42. When the slider 41 is at the stop position P 5, the stopping face 413 resists the baffle 210, so that the door panel 200 is actually in the closed status.

Referring to FIG. 1 to FIG. 8, in the embodiment, the though hole 411 comprises a first protrusion 411a on one inner side edge thereof in adjacent to the elastic member 42, and a second protrusion 411b on another inner side edge thereof away from the elastic member 42. The first protrusion 411a is arranged at a first height H 1, and the second protrusion 411b is arranged at a second height H 2, wherein the first height H 1 is lower than the second height H 2.

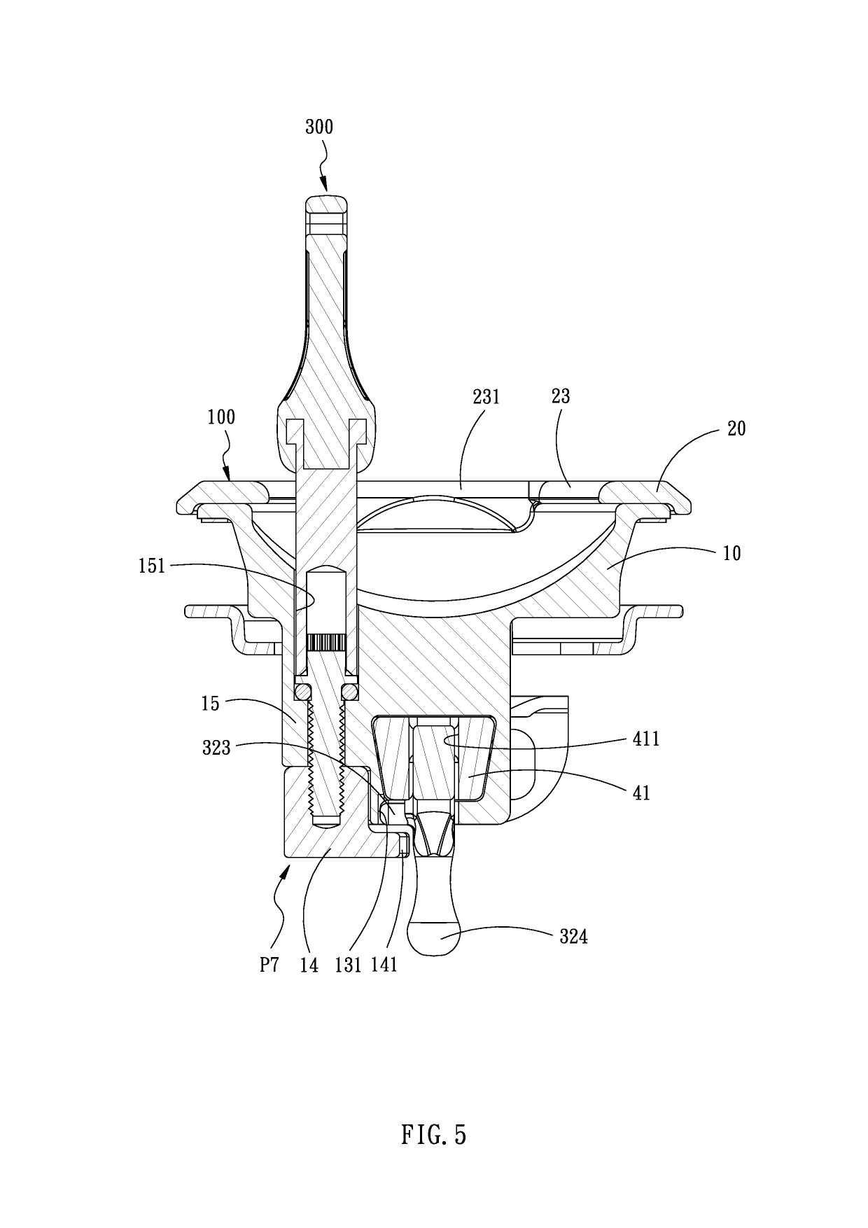

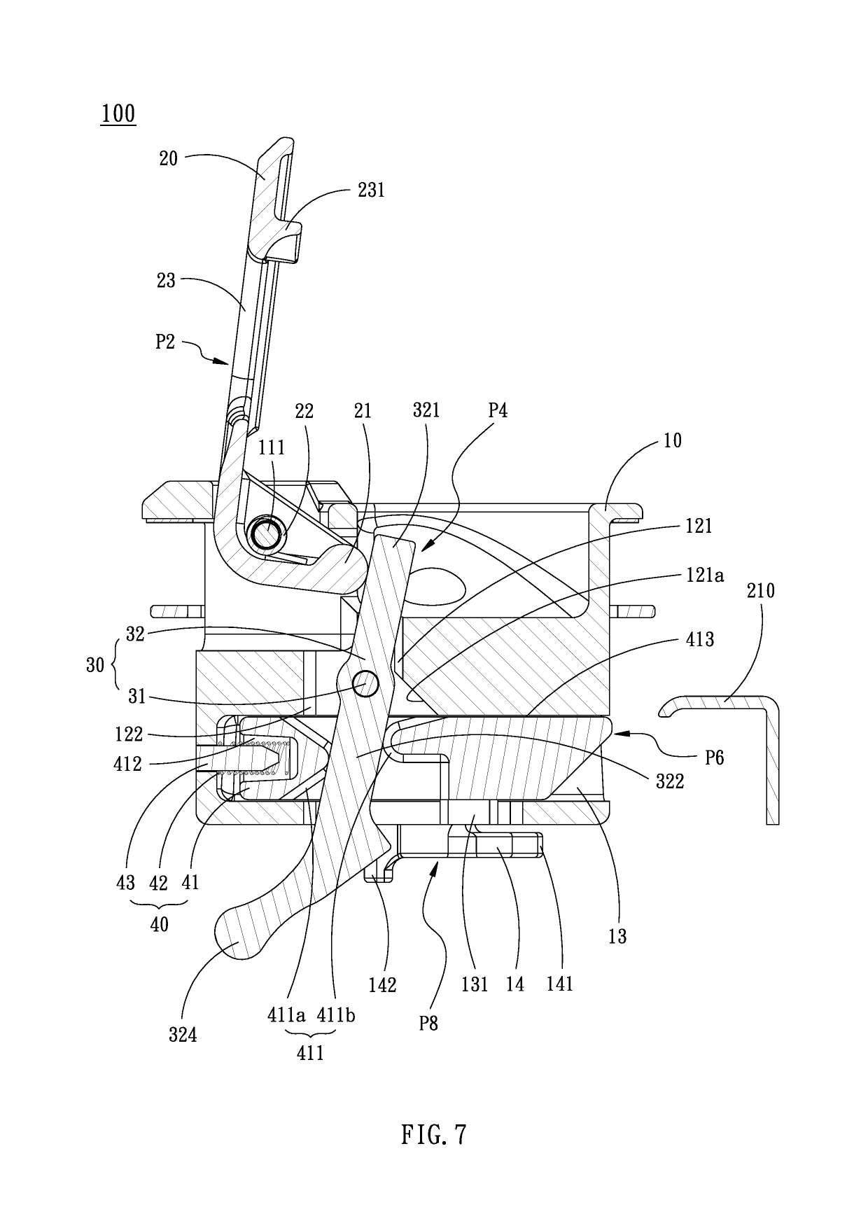

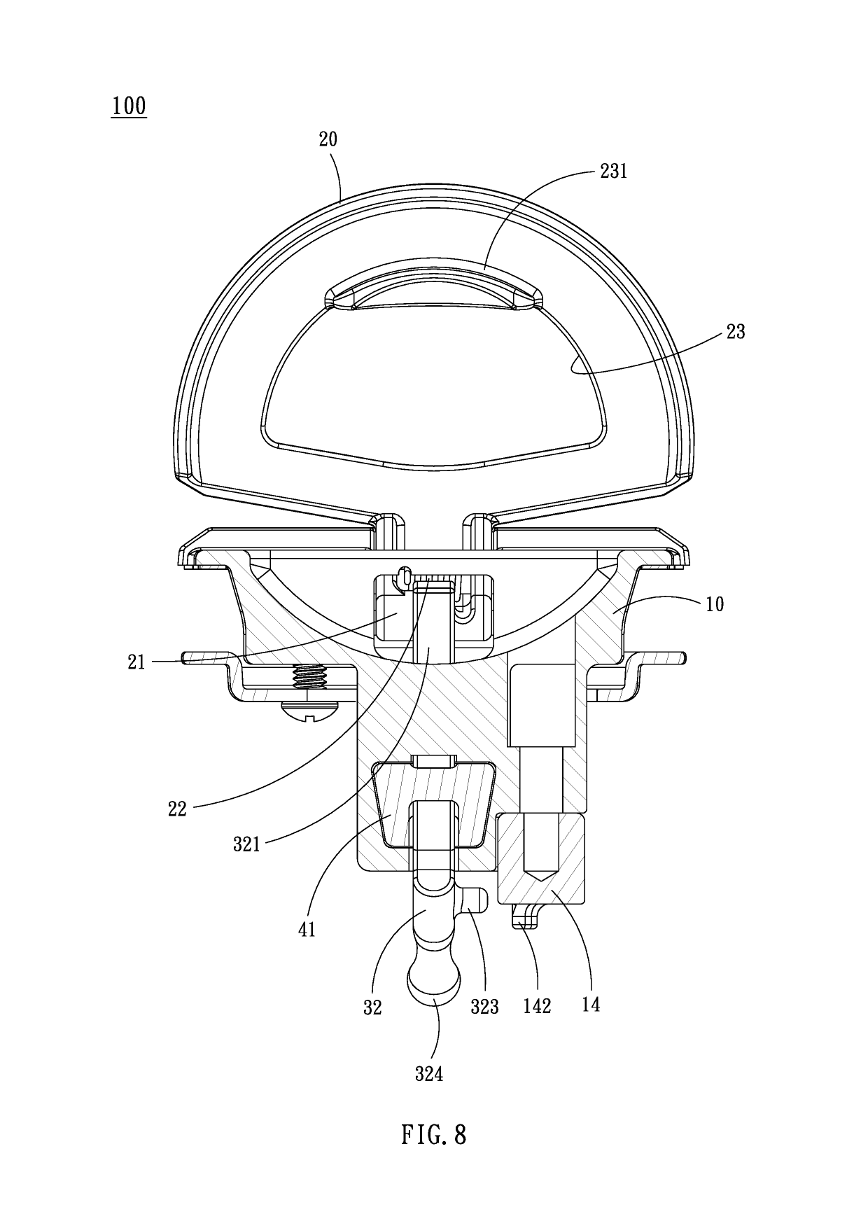

With such configuration, referring to FIG. 4, FIG. 5, FIG. 7, and FIG. 8, due to the two side walls (the first side wall 121 and the second side wall 122) of the installation hole 12 disposed at different heights, the two protrusions (the first protrusion 411 a and the second protrusion 411b) of the through hole 411 disposed at different heights, and the inclined section 121a, the rod part 32 is allowed to rotate between the first position P 3 and the second position P 4, and simultaneously drive the handle 20 to sway and drive the slider 41 to slide, whereby the forward latching handle 100 is switched between the locked status and the open status.

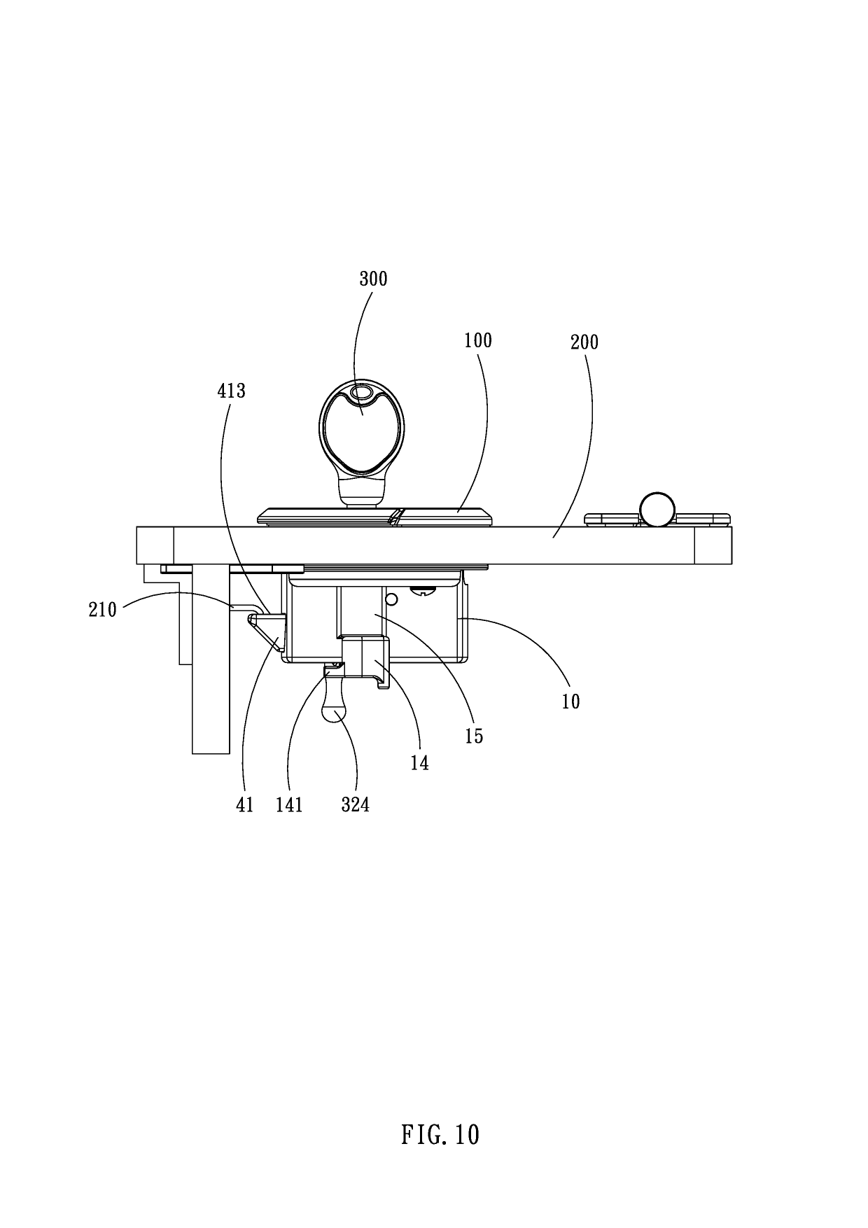

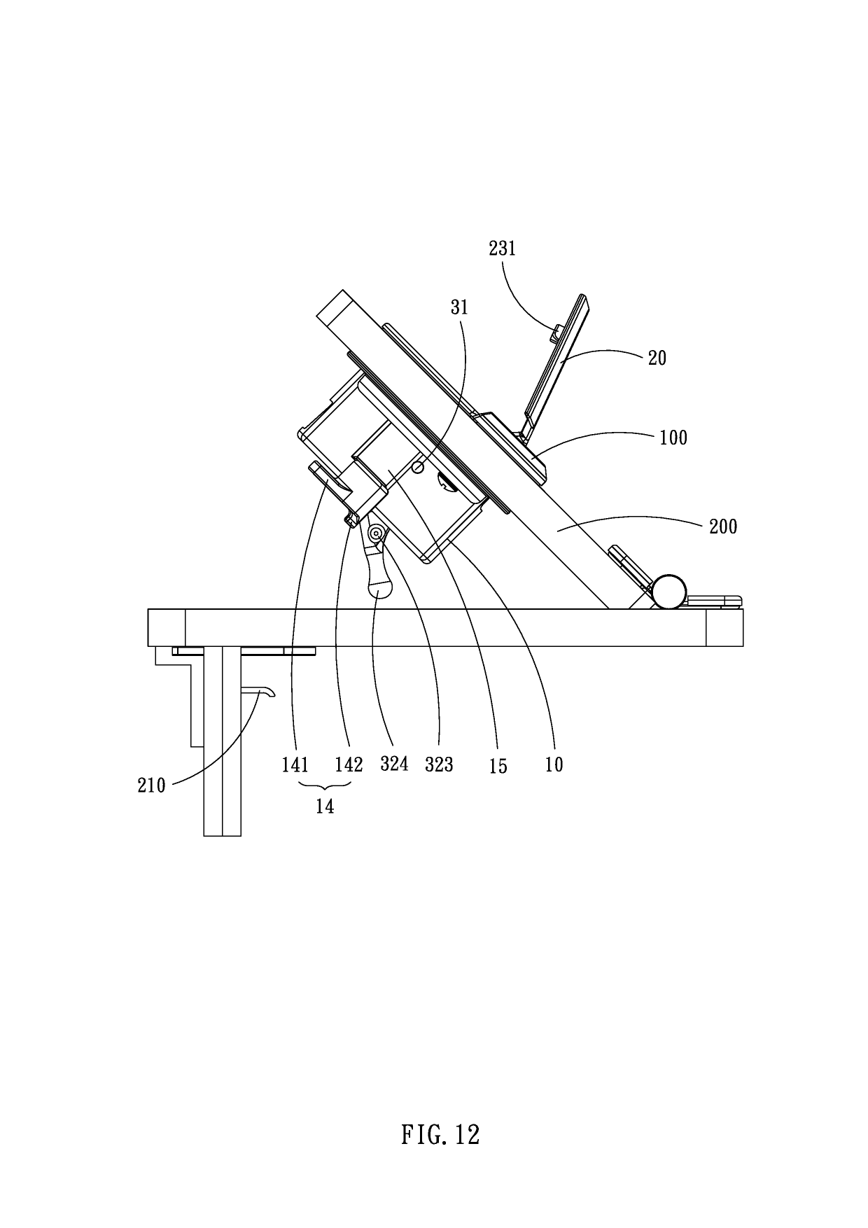

Referring to FIG. 4, FIG. 5, FIG. 7, FIG. 8, FIG. 10, and FIG. 12, in the embodiment, the elastic member 42 permanently provides the pushing force to control the slider 41 to resist the baffle 210 at the stop position P 5, and simultaneously drives the rod part 32 at the first position P 3 and the handle 20 at the closed position P 1, whereby the forward latching handle 100 is normally in the locked status. When the user grips the grip part 231 to pivot the handle 20 from the closed position P 1 to the open position P 2, the pushing part 21 pushes the rod part 32 to the second position P 4, and simultaneously drives the slider 41 to move to the avoidance position P 6, so as to remove the stopping relationship between the slider 41 and the baffle 210, whereby the user opens the door panel 200 by use of the present application.

Referring to FIG. 4, FIG. 5, FIG. 7, and FIG. 8, in the embodiment, the main body 10 comprises a position limiting member 14 disposed on one side of the outer edge of the mounting slot 13. The position limiting member 14 comprises a protruding position limiting part 141. The position limiting part 141 is allowed to move between a position limiting position P 7 and an avoidance position P 8. The rod part 32 comprises a position limiting block 323 protruding on the second linkage end 322 along the radial direction of the main body 10. When the position limiting part 141 is at the position limiting position P 7, the position limiting part 141 stops the position limiting block 323, so as to limit the rod part 32 at the first position P 3. Therefore, the position limiting member 14 is able to limit the rod part 32 at the first position P 3, so as to limit the forward latching handle 100 in the locked status.

Referring to FIG. 5, in the embodiment, the mounting slot 13 comprises an accommodation hole 131 on one side thereof away from the installation hole 12, and the accommodation hole 131 accommodates the position limiting block 323.

Referring to FIG. 1 to FIG. 8, in the embodiment, the main body 10 further comprises a control member 15 passing therethrough along the axial direction of the main body 10 to be connected to the position limiting member 14. The control member 15 comprises a lock hole 151, in which the user inserts a key 300 and rotates the key 300 to rotate the control member 15, so as to drive the position limiting member 14 to move between the position limiting position P 7 and the avoidance position P 8.

Referring to FIG. 4, FIG. 5, FIG. 7, FIG. 8, FIG. 10, and FIG. 12, in the embodiment, the position limiting member 14 comprises an actuating part 142 protruding on one side thereof away from the position limiting part 141. The actuating part 142 controls the position limiting member 14 to move between the position limiting position P 7 and the avoidance position P 8. The rod part 32 comprises a pulling block 324 protruding on one side of the second linkage end 322 away from the first linkage end 321. Therefore, if the door panel 200 is applied to a building as the door optionally separating neighboring spaces (such as a room door or a toilet door), when the user is locked inside, the user is still allowed to use the actuating part 142 to control the position limiting member 14 to move to the avoidance position P 8, and pull the pulling block 324 to control the rod part 32 at the second position P 4, such that the forward latching handle 100 is in the open status, thereby opening the door panel 200.

With the foregoing configuration, the present application achieves following effects.

The handle 20 moves from the closed position P 1 to the open position P 2 in a direction identical to the opening direction of the door panel 200. Therefore, the user is able to more smoothly and conveniently open the door panel 200.

When the user closes the door panel 200 and removes the external force imposed thereof, the recover member 22 of the handle 20 and the elastic member 42 of the stopping device 40 efficiently drive the slider 41 to move to the stop position P 5, whereby the forward latching handle 100 is quickly recovered to the locked status, effectively closing the door panel 200, thereby facilitating the convenience of use and saving time cost.

If the door panel 200 is applied to a building as the door optionally separating neighboring spaces (such as a room door or a toilet door), when the user is locked inside, the user is still allowed to use the actuating part 142 to control the position limiting member 14 to move to the avoidance position P 8, and pull the rod part 32 at the second position P 4, such that the forward latching handle 100 is in the open status, thereby opening the door panel 200.

Although particular embodiments of the application have been described in detail for purposes of illustration, various modifications and enhancements may be made without departing from the spirit and scope of the application. Accordingly, the application is not to be limited except as by the appended claims.

What is claimed is:

1. A forward latching handle disposed on a door panel for controlling the door panel to open and close, the door panel having a baffle on one side thereof, the forward latching handle comprising:
a main body comprising a pivot part, an installation hole, and a mounting slot; the pivot part having a pivot shaft, the installation hole passing through the main body along an axial direction of the main body, the mounting slot being arranged along a radial direction of the main body and in communication with the installation hole;
a handle pivotally connected to the pivot shaft and pivotable about the pivot shaft between a closed position and an open position, the handle having a pushing part disposed on one side in adjacent to the installation hole, the handle moving from the closed position to the open position along a direction which is identical to an opening direction of the door panel;
a linkage comprising a shaft part and a rod part, the shaft part passing through the installation hole along the radial direction of the main body, the rod part rotationally mounted around the shaft part and rotating about the shaft part between a first position and a second position, the rod part having a first linkage end and an opposite second linkage end, the first linkage end abutting against the pushing part; and
a stopping device comprising a slider and an elastic member, the slider slidably disposed in the mounting slot along the radial direction of the main body, the elastic member abutting against one side of the slider, the slider having a through hole through which the second linkage end passes to abut against, the slider slidably moving between a stop position and an avoidance position;
wherein the elastic member provides a pushing force to control the slider to push the baffle at the stop position, and simultaneously controls the rod part at the first position and the handle at the closed position; when the handle pivots from the closed position to the open position, the pushing part pushes the rod part to the second position, and simultaneously controls the slider to move to the avoidance position.

2. The forward latching handle of claim 1, wherein the handle comprises a recover member mounted around the pivot shaft; the recover member provides a recovering force to control the handle to be normally at the closed position.

3. The forward latching handle of claim 1, wherein the handle comprises a grip hole passing therethrough, with a grip part disposed on an inner periphery of the grip hole, such that the grip part is gripped to control the handle to pivot between the closed position and the open position.

4. The forward latching handle of claim 1, wherein the stopping device further comprises a positioning member disposed on one side of the elastic member away from the slider; the slider comprises a positioning hole disposed on one side thereof in adjacent to the elastic member; the elastic member has one end mounted around the positioning member and another end inserted in the positioning hole.

5. The forward latching handle of claim 1, wherein the slider comprises a protruding stopping face on one side thereof away from the elastic member; when the slider is at the stop position, the stopping face resists the baffle.

6. The forward latching handle of claim 1, wherein the though hole comprises a first protrusion on one inner side edge thereof in adjacent to the elastic member, and a second protrusion on another inner side edge thereof away from the elastic member; the first protrusion is arranged at a height lower than a height at which the second protrusion is arranged.

7. The forward latching handle of claim 1, wherein the main body comprises a position limiting member disposed on one side of an outer edge of the mounting slot; the position limiting member comprises a protruding position limiting part; the position limiting part is allowed to move between a position limiting position and an avoidance position; the rod part comprises a position limiting block protruding on the second linkage end along the radial direction of the main body; when the position limiting part is at the position limiting position, the position limiting part stops the position limiting block, so as to limit the rod part at the first position.

8. The forward latching handle of claim 7, wherein the mounting slot comprises an accommodation hole on one side thereof away from the installation hole; the accommodation hole accommodates the position limiting block.

9. The forward latching handle of claim 7, wherein the main body further comprises a control member passing therethrough along the axial direction of the main body to be connected to the position limiting member; the control member comprises a lock hole, in which a key is inserted to be rotated to rotate the control member, so as to drive the position limiting member to move between the position limiting position and the avoidance position.

10. The forward latching handle of claim 7, wherein the position limiting member comprises an actuating part protruding on one side thereof away from the position limiting part; the actuating part controls the position limiting member to move between the position limiting position and the avoidance position.
